(19) United States
(12) Patent Application Publication
(10) Pub. No.: US 2007/0218761 A1
(43) Pub. Date: Sep. 20, 2007

(54) Electric connector having separated grounding structure

(75) Inventor: Chun-Ying Liao, Gucishan Township (TW)

Correspondence Address: TROXELL LAW OFFICE PLLC;SUITE 1404, 5205 LEESBURG PIKE, FALLS CHURCH, VA, 22041, US

(73) Assignee: Speed Tech Corp.

(21) Appl. No.: 11/377,304

(22) Filed: Mar. 17, 2006

(51) Int. Cl. H01R 13/648

(52) U.S. Cl. 439/607

(57) ABSTRACT

The present invention separates grounding units from a shell of an electric connector and makes them fabricated individually and later assembled together so that wastes over working hours, working procedures and bad electroplating can be avoided and cost can be reduced at the same time.

### FIELD OF THE INVENTION

The present invention relates to an electric connector; more particularly relates to preventing wastes in working hours, working procedures and bad electroplating by using a grounding structure.

### DESCRIPTION OF THE RELATED ART

A general connector, as shown in FIG.6, comprises a plastic base 5 and a metal shell 6, where the plastic base 5 has at least one socket seat; the socket seat has at least one terminal 51 extending out of a bottom of the plastic base 5; an opening of the socket seat is corresponding to an end surface of the plastic base 5; the metal shell 6 is covered on the plastic base 5 over two side surfaces and a back surface and the metal shell 6 has more than one grounding terminal 61 extending out of a bottom end. Thus, when the connector is assembled on a circuit board, a grounding mechanism of the circuit board is obtained through the more than one grounding terminal 61 of the metal shell 6.

There, the above connector obtains a grounding mechanism with more than one grounding terminal 61 of the metal shell 6. Owing to the requirements on the appearance of the metal shell 6, the connector is usually made of stainless steel or cop per material. Regarding the stainless steel, tin is used over the grounding terminal 61 after the shape of the metal shell 6 is made, which results in wastes over working hours and working procedures and results in smears over the appearance of the metal shell 6. Regarding the copper material, the whole metal shell 6 is plated with copper right after the shape of the metal shell 6 is made, which quite often results in bad quality of the electroplating owing to an unstable current. Hence, the prior art does not fulfill users' requests on actual use.

### SUMMARY OF THE INVENTION

The main purpose of the present invention is to separately fabricate a shell and grounding units to be assembled later for preventing wastes in working hours, working procedures and bad electroplating.

To achieve the above purpose, the present invention is an electric connector having a separated grounding structure, comprising a base, a shell and more than one grounding unit, where the base has at least one socket seat; the socket seat has at least one terminal extending out of the base; an opening of the socket seat is corresponding to an end surface of the base; the shell is covered on two side surfaces and an end surface of the base; and the grounding unit is deposed between a surface of the shell and a corresponding surface of the base. Therein, each of the surfaces of the shell corresponding to the surfaces of the base has a concave part; and the grounding unit comprises a plate and more than one grounding terminal deposed on a rim of the plate, where the grounding unit is deposed in the concave part of the shell through the plate. Accordingly, a novel electric connector having a separated grounding structure is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a perspective view showing a preferred embodiment according to the present invention;

FIG. 2 is another perspective view showing the preferred embodiment according to the present invention;

FIG. 3 is an explosive view showing the preferred embodiment according to the present invention;

FIG. 4 is an A-A cross-sectional view showing the preferred embodiment according to the present invention;

FIG. 5 is a view showing a state of use of the preferred embodiment according to the present invention; and

FIG. 6 is an explosive view of a prior art.

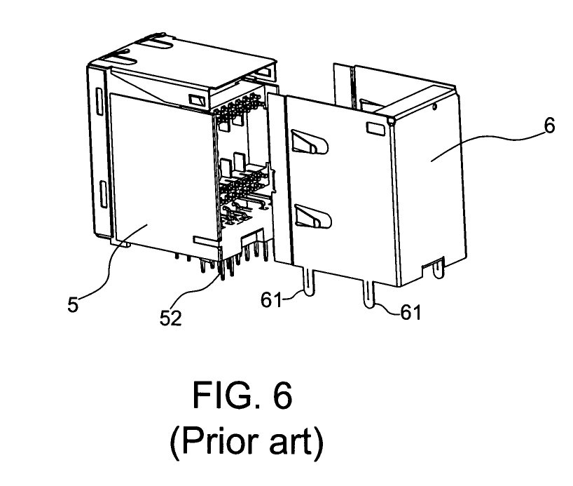

### DESCRIPTION OF THE PREFERRED EMBODIMENT

The following description of the preferred embodiment is provided to understand the features and the structures of the present invention.

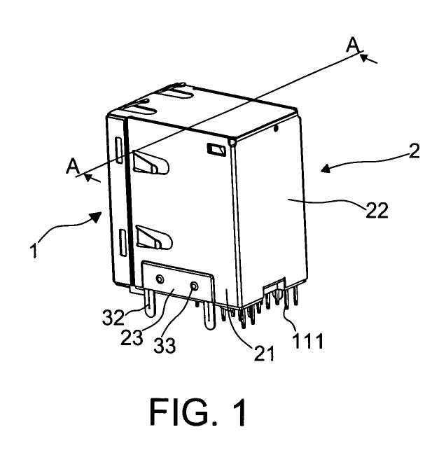

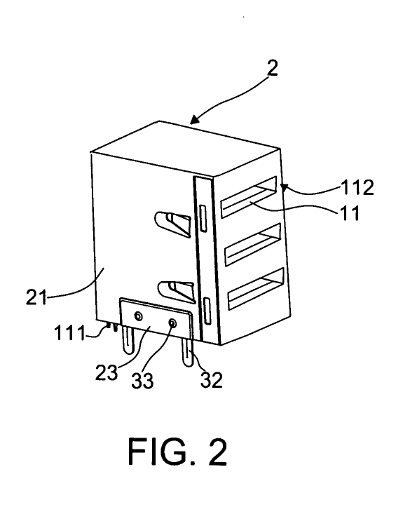

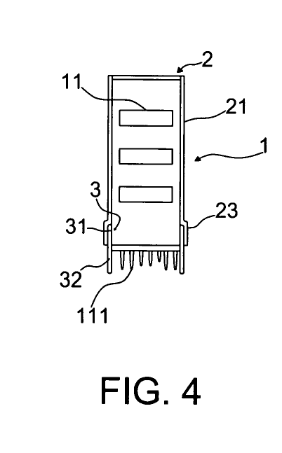

Please refer to FIG. 1 through FIG. 4, which are two perspective views, an explosive view and an A-A cross-sectional view showing a preferred embodiment according to the present invention. As shown in the figures, the present invention is an electric connector having a separated grounding structure, comprising a base 1, a shell 2 and more than one grounding unit, where the shell 2 and the grounding unit 3 are fabricated separately and are assembled together afterward so that wastes in working hours, working procedures and bad electroplating are avoided.

The base 1 is made of a plastic material; the base 1 has at least one socket seat 11; the socket seat 11 has at least one terminal 111 extending out of the base 1; and, the socket seat 11 has an opening 112 corresponding to an end surface of the base 1.

The shell 2 comprises two side boards 21, and a plate 22 between two rims of the side boards 21 at the same direction; the shell 2 covers the base 1 with two side surfaces and an end surface of the shell; the shell 2 is made of a metal material; each of the two side surfaces of the shell 2 has a concave part 23 (on the inner side of the side board 21); and the concave part 23 has more than one fixing mechanism, such as a fixing hole 231.

Each grounding unit 3 is a grounding structure for the connector; the grounding unit 3 is deposed between a side surface of the base 1 and a corresponding side surface of the shell 2 the grounding unit 3 comprises a plate 31 to be deposed in the concave part 21, and more than one grounding terminal 32 deposed on a rim of the plate 31; and, the plate 31 has more than one protrusion 33 on a surface of the plate and the protrusion 33 is corresponding to the fixing hole.

Thus, by the above structure, a novel electric connector having a separated grounding structure is obtained.

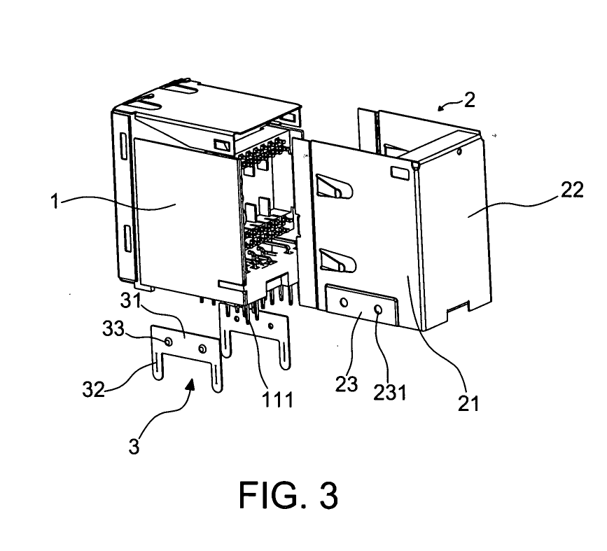

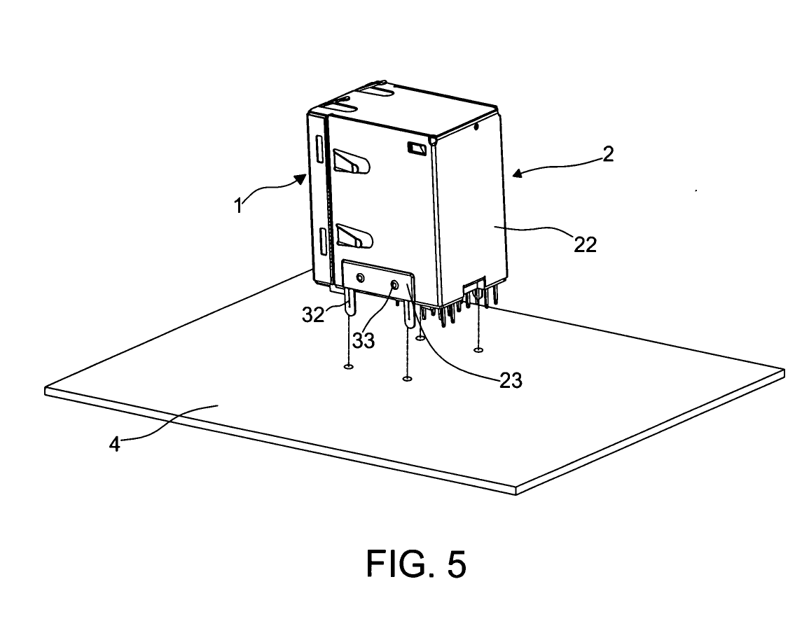

Please refer to FIG. 3 through FIG. 5, which are an explosive view and an A-A cross-sectional view showing the preferred embodiment and a view showing a state of use of the preferred embodiment, according to the present invention. As shown in the figures, when assembling the present invention, at least one socket seat 11 is deposed in a plastic base 11; at least one terminal 111 of the socket seat 11 is extended out of a bottom of a base 1; and an opening 112 of the socket seat 11 is corresponding to an end surface of the base 1. Then at least a grounding unit 3 is processed with an electroplating to be de posed in at least a concave part 23 of a shell 2 by a plate 31; and, protrusions 33 on a surface of the plate 31 are correspondingly fixed to fixing holes 2 31 of the concave part 23. Thus, the grounding unit 3 is set at a side surface of the shell 2. Then two side boards 21 of the shell 2 having the side surfaces with the grounding units 3 are deposed correspondingly on two side surfaces of the base 1. And, a plate 22 is covered on the back surface of the base 1. Thus, grounding units 3 are set between a side surface of the base 1 and a corresponding side surface of the shell 2 moreover, more than one grounding terminal 32 of the grounding unit 3 and at least one terminal of the socket seat 11 are extended to the same direction, so that a grounding mechanism for a connector is formed. When using the connector, more than one grounding terminal 32 of the grounding unit 3 and at least one terminal 111 of the socket seat 11 are simultaneously deposed on a circuit board 4 so that a grounding function is obtained for the connector, where, with such a simple mechanism, wastes in working hours, working procedures and bad electroplating are avoided. By separating a component of a shell 2 and other components of grounding units, the grounding units 3 are electroplated according to requirements while preventing the shell from smears after the electroplating and saving working hours and cost for removing solder joints.

The grounding unit 3 can also be fixed on the outside surface of the shell 2 so that the grounding unit 3 can be fixed at any place on the outside surface of the shell 2, where the fixing way can be locking, welding, riveting or embedding.

To sum up, the present invention is an electric connector having a separated grounding structure, where a shell and grounding units are separately fabricated to be assembled later for preventing wastes in working hours, working procedures and bad electroplating.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An electric connector having a separated grounding structure, comprising:
(a) a base, said base having at least a socket seat, said socket seat having at least one terminal extending out of said base, an opening of said socket seat corresponding to an end surface of said base;
(b) a shell, said shell covering on two side surfaces of said base and another end surface of said base; and
(c) more than one grounding unit, said grounding unit deposing between a side surface of said base and a corresponding side surface of said shell.

2. The electric connector according to claim 1,
where in said base is made of a plastic material.

3. The electric connector according to claim 1,
wherein said at least one terminal of said socket seat is extended out of an end surface of said base.

4. The electric connector according to claim 1,
wherein said side surface of said shell has a concave part and said concave part has more than one fixing hole.

5. The electric connector according to claim 1,
wherein said shell is made of a metal material.

6. The electric connector according to claim 1,
wherein said grounding unit comprises a plate having more than one protrusion on a surface of said plate; and said grounding unit comprises more than one grounding terminal deposing on a rim of said plate.

7. The electric connector according to claim 1,
wherein said more than one grounding unit is deposed on a surface of said shell opposite to said side surface of said shell.

8. The electric connector according to claim 7,
wherein said more than one grounding unit and said shell are fixed together in a way selected from a group consisting of locking, welding, riveting and embedding.

9. An electric connector having a separated grounding structure, comprising:
(a) a base;
(b) a shell; and
( c ) more than one grounding unit,
wherein said base has at least a socket seat, said socket seat has at least a terminal extending out of said base, and an opening of said socket seat is corresponding to an end surface of said base;
wherein said shell covers on two side surfaces of said base and an end surface of said base and two corresponding side surfaces of said shell to said two side surfaces of said base have a concave part for each side surface of said shell;
wherein said grounding unit comprises a plate having more than one protrusion on a surface of said plate, and more than one grounding terminal deposing on a rim of said plate; and
wherein said grounding unit is deposed between a side surface of said base and a corresponding side surface of said shell.

10. The electric connector according to claim 9,
wherein said at least one terminal of said socket seat is extended out of an end surface of said base.

11. The electric connector according to claim 9,
wherein said base is made of a plastic material.

12. The electric connector according to claim 9,
wherein said shell is made of a metal material.

13. The electric connector according to claim 9,
wherein said concave part has more than one fixing hole.

14. The electric connector according to claim 9,
wherein said plate has more than one protrusion on a surface of said plate.

15. The electric connector according to claim 9,
wherein said more than one grounding unit is deposed on a surface of said shell opposite to said side surface of said shell.

16. The electric connector according to claim 15,
wherein said more than one grounding unit and said shell are fixed together in a way selected from a group consisting of locking welding, riveting and embedding.
